(19) United States
(12) Patent Application Publication
(10) Pub. No.: US 2018/0192627 A1
(43) Pub. Date: Jul. 12, 2018

(54) Fishing Float Assembly

(71) Applicant: Richard Zak, Rosenburg, TX (US)

(72) Inventor: Richard Zak, Rosenburg, TX (US)

(21) Appl. No.: 15/403,610

(22) Filed: Jan. 11, 2017

(51) Int. Cl. A01K 93/00; A01K 91/04; A01K 85/01

(52) U.S. Cl. CPC A01K 93/00; A01K 85/01; A01K 91/04

(57) ABSTRACT

A fishing float assembly includes a float that may float in water. The float is selectively coupled to a fishing line thereby facilitating the float to be cast into the water. A plurality of beads is provided and each of the beads is positioned in the float. The plurality of beads retains the float in an upright position in the water.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information Disclosed Under 37 CFR 1.97 and 1.98

The disclosure and prior art relates to float devices and more particularly pertains to a new float device for being cast into and floating on water during fishing activities.

### BRIEF SUMMARY OF THE INVENTION

An embodiment of the disclosure meets the needs presented above by generally comprising a float that may float in water. The float is selectively coupled to a fishing line thereby facilitating the float to be cast into the water. A plurality of beads is provided and each of the beads is positioned in the float. The plurality of beads retains the float in an upright position in the water.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective phantom view of a fishing float assembly according to an embodiment of the disclosure.

FIG. 2 is a cross sectional view take along line 2-2 of FIG. 1 of an embodiment of the disclosure.

FIG. 3 is a cross sectional view taken along line 3-3 of FIG. 2 of an embodiment of the disclosure.

FIG. 4 is a perspective in-use view of an embodiment of the disclosure.

### DETAILED DESCRIPTION OF THE INVENTION

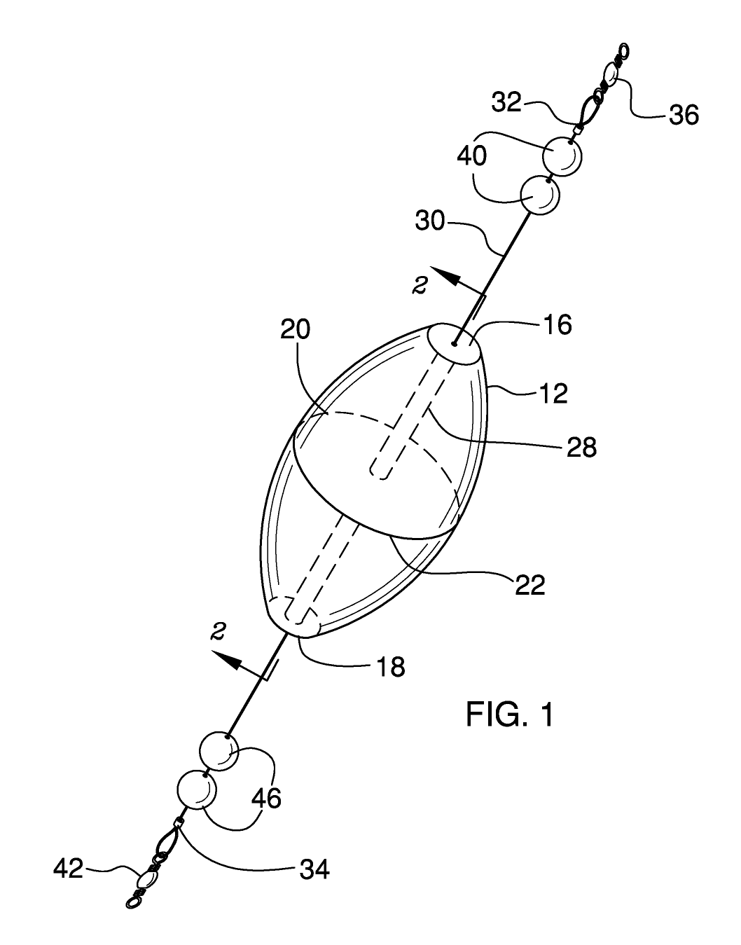

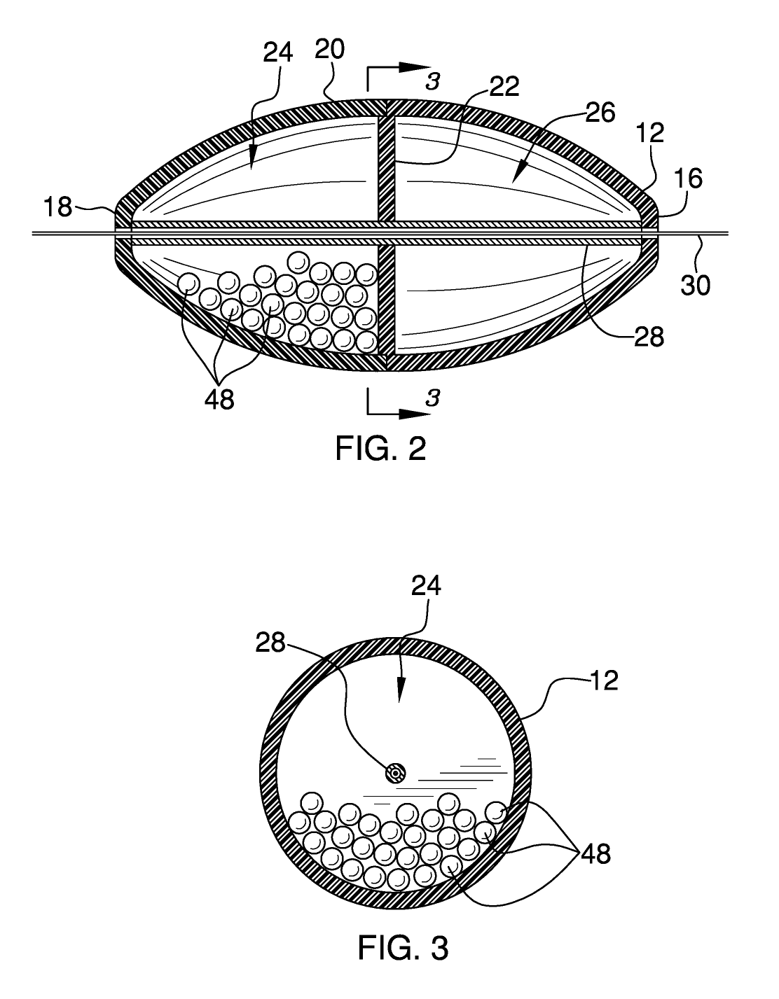

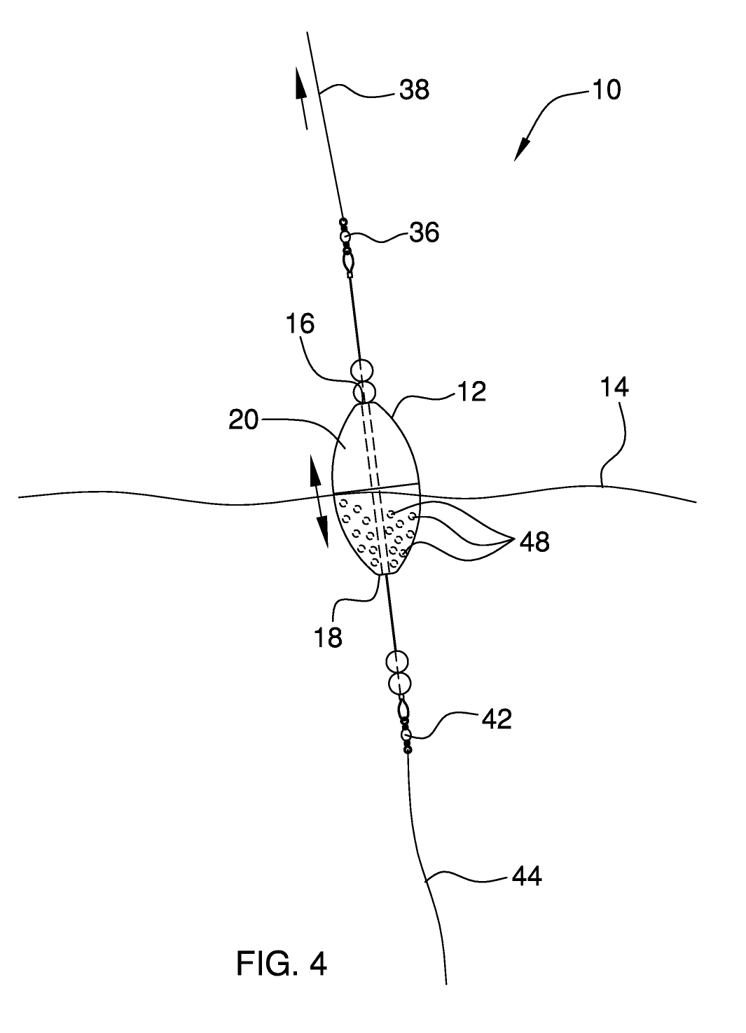

With reference now to the drawings, and in particular to FIGS. 1 through 4 thereof, a new float device embodying the principles and concepts of an embodiment of the disclosure and generally designated by the reference numeral 10 will be described.

As best illustrated in FIGS. 1 through 4, the fishing float assembly 10 generally comprises a float 12 that may be cast into and float in water 14. The water 14 may be ocean water, lake water, river water or any other water that harbors fish life. The float 12 has a first end 16, a second end 18 and an outer wall 20 extending therebetween. The outer wall 20 is continuous and tapered between first end 16 and the second end 18 such that the float 12 has an ovoid shape. The outer wall 20 has a color that contrasts with the color of water 14 thereby enhancing visibility of the float 12 when float 12 is cast into the water 14.

The float 12 is substantially hollow and a partition 22 is positioned within the float 12 to define a first chamber 24 and a second chamber 26 in the float 12. The float 12 is filled with air such that the float 12 is buoyant in the water 14. The partition 22 is centrally positioned between the first end 16 and the second end 18. Additionally, the first chamber 24 is fluidly discrete from the second chamber 26. A tube 28 is positioned within the float 12 and the tube 28 extends through the first end 16 and the second end 18.

A wire 30 is provided and the wire 30 slidably extends through the tube 28. The wire 30 has a primary end 32 and a secondary end 34. The wire 30 may be comprised of seven strand titanium wire 30 or the like such that the wire 30 resists chafing and breaking. Moreover, the wire 30 may have a breaking strength ranging between approximately 45.0 kg and 55.0 kg.

A first swivel 36 is coupled to the primary end 32 and the first swivel 36 is attached to a fishing line 38. Thus, the float 12 may be cast into the water 14. The fishing line 38 may be a fishing line of fishing rod or the like. A plurality of first balls 40 is provided and each of the first balls 40 is coupled to the wire 30. Each of the first balls 40 is positioned between the first end 16 of the float 12 and the first swivel 36 to inhibit the float 12 from passing beyond the first swivel 36.

A second swivel 42 is coupled to the secondary end 34 and the second swivel 42 is attached to a hook 44 thereby facilitating the hook 44 to be cast into the water 14. The hook 44 may include a leader or other line extending between the second swivel 42 and the hook 44. A plurality of second balls 46 is provided and each of the second balls 46 is coupled to the wire 30. Each of the second balls 46 is positioned between the second end 18 of the float 12 and the second swivel 42 to inhibit the float 12 from passing the second swivel 42.

A plurality of beads 48 is provided and each of the beads 48 is positioned in the float 12. Moreover, each of the beads 48 is positioned in the first chamber 24 in the float 12. Each of the beads 48 is comprised of a metallic material and each of the beads 48 has a weight ranging between 3.0 grams and 5.0 grams. The combined weight of the beads 48 in the float 12 enhances casting the float 12. Each of the beads 48 falls to the second end 18 of the float 12 when the float 12 is cast into the water 14. In this way the plurality of beads 48 retains the float 12 in an upright position in the water 14 having the first end 16 of the float 12 extending out of the water 14. Additionally, each of the beads 48 frictionally engages the outer wall 20 to make noise for attracting fish.

In use, the first swivel 36 is attached to the fishing line 38 and the hook 44 is attached to the second swivel 42. The float 12 and hook 44 are cast into the water 14 in the convention of fishing. The combined weight of the beads 48 in the float 12 enhances a casting distance of the float 12. Additionally, the beads 48 retain the float 12 in an upright position in the water 14 thereby enhancing visibility of the float 12. The beads 48 frictionally engage the outer wall 20 of the float 12 thereby making a noise for attracting fish.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing float assembly being configured to float on a body of water, said assembly comprising:
a float being configured to float in water, said float being configured to be coupled to a fishing line thereby facilitating the float to be cast into the water; and
a plurality of beads, each of said beads being positioned in said float wherein said plurality of beads is configured to retain said float in an upright position in the water.

2. The assembly according to claim 1, wherein said float has a first end, a second end and an outer wall extending therebetween, said outer wall being continuous and tapered between first end and said second end such that said float has an ovoid shape, said float being substantially hollow.

3. The assembly according to claim 2, wherein said float has a partition being positioned within said float to define a first chamber and a second chamber in said float, said partition being centrally positioned between said first end and said second end.

4. The assembly according to claim 2, further comprising a tube being positioned within said float, said tube extending through said first end and said second end.

5. The assembly according to claim 1, further comprising:
a wire extending through said float, said wire having a primary end; and
a first swivel being coupled to said primary end wherein said first swivel is configured to be attached to a fishing line thereby facilitating said float to be cast into the water.

6. The assembly according to claim 5, further comprising a plurality of first balls, each of said first balls being coupled to said wire, each of said first balls being positioned between said first end of said float and said first swivel such that each of said first balls inhibits said float from passing therebeyond.

7. The assembly according to claim 1, further comprising:
a wire extending through said float, said wire having a secondary end; and
a second swivel being coupled to said secondary end wherein said second swivel is configured to be attached to a hook thereby facilitating the hook to be cast into the water.

8. The assembly according to claim 7, further comprising a plurality of second balls, each of said second balls being coupled to said wire, each of said second balls being positioned between said second end of said float and said second swivel such that each of said second balls inhibits said float from passing therebeyond.

9. The assembly according to claim 3, wherein each of said beads is positioned in said first chamber in said float, each of said beads frictionally engaging said outer wall wherein said plurality of beads is configured to make noise to attract fish.

10. A fishing float assembly being configured to float on a body of water, said assembly comprising:
a float being configured to float in water, said float having a first end, a second end and an outer wall extending therebetween, said outer wall being continuous and tapered between first end and said second end such that said float has an ovoid shape, said float being substantially hollow, said float having a partition being positioned within said float to define a first chamber and a second chamber in said float, said partition being centrally positioned between said first end and said second end;
a tube being positioned within said float, said tube extending through said first end and said second end;
a wire slidably extending through said tube, said wire having a primary end and a secondary end;
a first swivel being coupled to said primary end wherein said first swivel is configured to be attached to a fishing line thereby facilitating said float to be cast into the water;
a plurality of first balls, each of said first balls being coupled to said wire, each of said first balls being positioned between said first end of said float and said first swivel such that each of said first balls inhibits said float from passing therebeyond;
a second swivel being coupled to said secondary end wherein said second swivel is configured to be attached to a hook thereby facilitating the hook to be cast into the water;
a plurality of second balls, each of said second balls being coupled to said wire, each of said second balls being positioned between said second end of said float and said second swivel such that each of said second balls inhibits said float from passing therebeyond; and
a plurality of beads, each of said beads being positioned in said float wherein said plurality of beads is configured to retain said float in an upright position in the water, each of said beads being positioned in said first chamber in said float, each of said beads frictionally engaging said outer wall wherein said plurality of beads is configured to make noise to attract fish.
